(19) United States
(12) Patent Application Publication
(10) Pub. No.: US 2015/0288813 A1
(43) Pub. Date: Oct. 8, 2015

(54) SYSTEM AND METHOD FOR SENDING COMMUNICATION REQUESTS TO REGISTERED USERS VIA CELLULAR NETWORK

(71) Applicant: Richard DesBrisay, Moncton (CA)

(72) Inventors: Richard DesBrisay, Moncton (CA); William Robblee, Moncton (CA); John Leahy, Bedford (CA)

(21) Appl. No.: 14/679,612

(22) Filed: Apr. 6, 2015

Related U.S. Application Data
(60) Provisional application No. 61/975,464, filed on Apr. 4, 2014.

(51) Int. Cl. H04M 3/42

(52) U.S. Cl. CPC H04M 3/42008; H04M 3/42382

(57) ABSTRACT

The system and method for sending a communication request to a registered user is generally comprised of a first step of creating an account in an online directory of registered users. The second step is comprised of logging into the online directory and searching for other registered users. Once the requisite registered user is found, the third step is to send said registered user a communication request. Once received, the registered user has the prerogative to initiate a call with the callee by dialing his or her phone number, or can also opt to send a text message (SMS) or other similar type of message instead.

This application claims the benefit of U.S. Provisional Patent Application No. 61/975,464 filed Apr. 4, 2014, entitled System and Method for Sending Communication Requests to Registered Users Via Cellular Network.

### FIELD OF THE INVENTION

The present invention relates to the field of cellular telephony, and more specifically to a method of initiating a communication request through a pre-determined database of users to initiate a cellular telephone communication via pre-existing cellular networks.

### BACKGROUND

Cellular devices have become increasingly prevalent in the past two decades. The percentage of cellular telephone users has grown exponentially; and we are at a point where it is estimated that there are 87 mobile phones per 100 citizens in the world, and over 90% of Americans operate a cellular telephone.

Commensurate with the rise in cellular telephone users, there has been a steady decline in the use of the telephone directories, as most people only list their home telephone number and prefer to keep their cellular telephone number private.

Indeed, there do not appear to be any predominant and useful directories of cellular telephone users, and the ones that do exist are generally inadequate and/or incomplete.

As such, there is a need for a type of cellular telephone directory which can both preserve the anonymity of users and enable said users to still be reached by certain persons that are deemed acceptable. This type of cellular telephone directory would enable users to register and include public personal information about themselves, and additionally privately list their cellular number, which would remain private until chosen otherwise. Other users would be able to conduct a search through the database of known public information, and find the user that they wish to communicate with. They would be able to initiate a call request by sending a Short Message Service (SMS), or any other type of MNS (Mobile Notification Service) identifying themselves. The callee would then be able to respond to this message in the affirmative, ignore the message or respond negatively. All of this would be done through the directory; however, said directory would communicate to the user via existing cellular towers and services. In other words, no software would be required by the callee in order to initiate a conversation.

Some systems have been devised in order to address some of the aforementioned issues; however, none have been successful. U.S. Pat. No. 8,521,817 (Ryan et al.) and U.S. Pat. No. 7,424,541 (Bourne), are examples of such devices.

Ryan et al.'s system and method describes a system to form a unique, private and personal virtual social network based on predetermined criteria. A first user has unique information identifying him or her, and can be matched to a second user with his or her unique information provided that they have a connection (a third user) in common. Once the qualities of the first and second users match, the system will send a message to the first user via an SMS that the second user is in geographical proximity to him or her, and include some information on the second user. If the first user wishes to communicate and link up with the second user, the first user can send a message which is received by the second user and the second user can choose to respond, thereby providing his or her mobile cellular number. The shortfall of this system is that it is chosen randomly based on pre-determined criteria that the first and second users select. Indeed, one cannot search for one user based on these preferences and communicate with that person. Further, and generally speaking, this system is designed for two users who do not know each other, not for one user who knows the second and wishes to communicate with him or her.

Meanwhile, Bourne's system discloses a similar type of method in order for two individuals to communicate with one another. As is the case in the present method, the user must register for the service using a client machine, and will include personal information to establish a professional profile. When users are within a physical proximity of one another, the server will determine whether or not they are also within an intellectual proximity of one another. If so, the server will send a message to each user, anonymously but by giving minimal information about the other to see if they would like to communicate. It includes a premium call number and PIN code to enter by each user to communicate. Similar to Ryan et al.'s system and method, this system is based on a computer algorithm to determine whether both users are compatible on an intellectual level. As such, both users are anonymous one to the other and one cannot search the database for the other; the computer performs this duty. It is an overcomplicated system that can preserve anonymity between two users and ultimately put them in contact with one another, but the objective of the present invention is to have a database of registered users that one can freely search in order to obtain the cellular telephone number of the other, without disclosing this number until the second user accepts to release the information.

### SUMMARY

In an aspect, a system for providing method for sending a communication request to a second registered user via a cellular network is disclosed, the system comprising: an application for providing a directory of registered users with each registered user having at least one identifier and one unique identifier; an application for accepting an identifier search query from a first registered user; an application for matching the identifier from the identifier search query with the second registered user from the directory; and an application for sending the communication request from the first registered user to the unique identifier of the second registered user; wherein the communication request is comprised of the confidential identifier of the first registered user.

In another aspect, a method for sending a communication request to a second registered user via a cellular network it disclosed, the method comprising: providing a directory of registered users with each registered user having at least one identifier and one unique identifier; accepting an identifier search query from a first registered user; matching the identifier from the identifier search query with the second registered user from the directory; and sending the communication request from the first registered user to the unique identifier of the second registered user; wherein the communication request is comprised of the confidential identifier of the first registered user.

### BRIEF DESCRIPTION OF THE DRAWINGS

It will now be convenient to describe the invention with particular reference to one embodiment of the present invention. It will be appreciated that the drawings relate to one embodiment of the present invention only and are not to be taken as limiting the invention.

FIG. 1 is a simplistic schematic representation of the logical structure of the registration and directory search processes, according to one embodiment of the present invention;

FIG. 2 is a schematic diagram of the logical structure of the registration process, according to one embodiment of the present invention;

FIG. 3 is a schematic diagram of the logical structure of the directory search and contact process, according to one embodiment of the present invention;

FIG. 3a is a schematic diagram of the logical structure of the directory search and contact process, according to a second embodiment of the present invention;

FIG. 4 is a screenshot of the login page, according to one embodiment of the present invention;

FIG. 5 is a screenshot of the registration page, according to one embodiment of the present invention;

FIG. 6 is a screenshot of the registration page, according to one embodiment of the present invention;

FIG. 7 is a screenshot of the confirmation screen page, according to one embodiment of the present invention;

FIG. 8 is a screenshot of the list of users page, according to one embodiment of the present invention;

FIG. 9 is a screenshot of the PID information of a specific user, according to one embodiment of the present invention;

FIG. 10 is a screenshot of the confirmation message page, according to one embodiment of the present invention; and,

FIG. 11 is a screenshot of the SMS received by a user, according to one embodiment of the present invention.

### DETAILED DESCRIPTION

The present invention will now be described more fully hereinafter with reference to the accompanying drawings, in which preferred and other embodiments of the invention are shown. No embodiment described below limits any claimed invention and any claimed invention may cover processes or apparatuses that are not described below. The claimed inventions are not limited to apparatuses or processes having all the features of any one apparatus or process described below or to features common to multiple or all of the apparatuses described below. It is possible that an apparatus or process described below is not an embodiment of any claimed invention. The applicants, inventors or owners reserve all rights that they may have in any invention claimed in this document, for example the right to claim such an invention in a continuing application and do not intend to abandon, disclaim or dedicate to the public any such invention by its disclosure in this document.

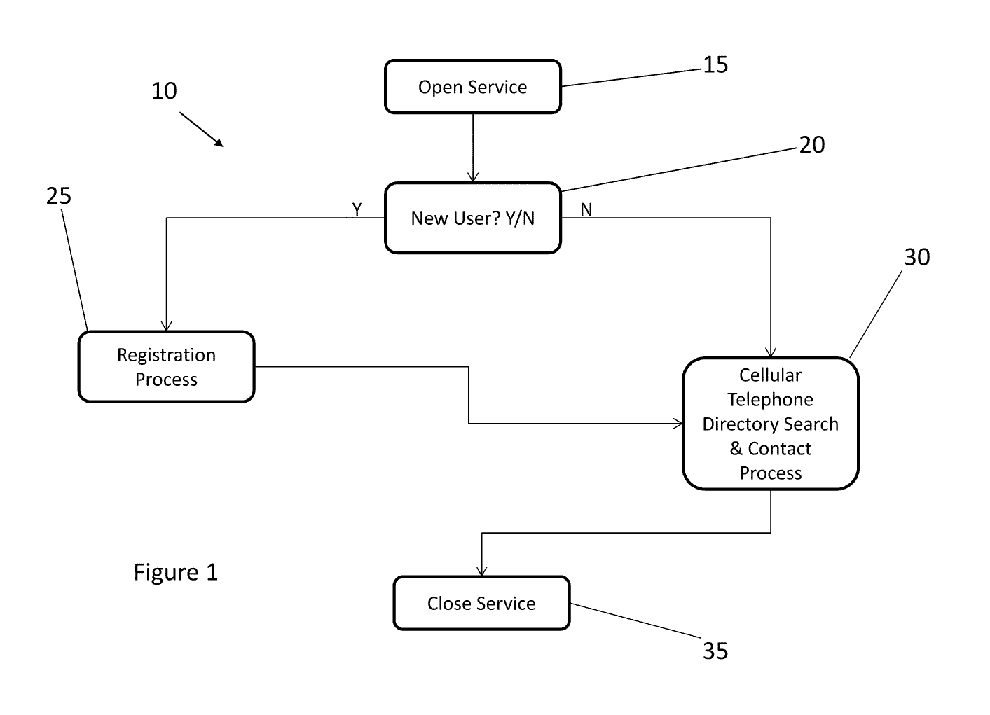

With reference to FIG. 1 and according to one embodiment of the present invention, the logic diagram of the method and system for registering a device and sending a communication request to a registered user 10 is shown, generally comprising of step 15, which consists of opening the application or getting into the service. In order to properly open the service per step 15, a user may have access to a smart phone device which has Internet browsing capabilities. Step 20 will need to determine, once the application is in use, whether the user is new or whether it is a registered user. If the user is new, the user must become registered in order to use the service. Indeed, an unregistered user cannot search the database and needs a unique username and password in order to do so. This feature adds a level of security to the system 10 which will reduce spam generated by false users. If the user is new to the system 10, he or she must go through step 25 which consists of the registration process. Step 25 is further described below. Conversely, if the user is registered, or once step 25 is complete, he or she may use the system 10 and proceed to step 30 which consists of the cellular telephony directory search and contact. Said step 30 is further described below. Once the search and contact in step 30 is complete, the service is terminated at step 35.

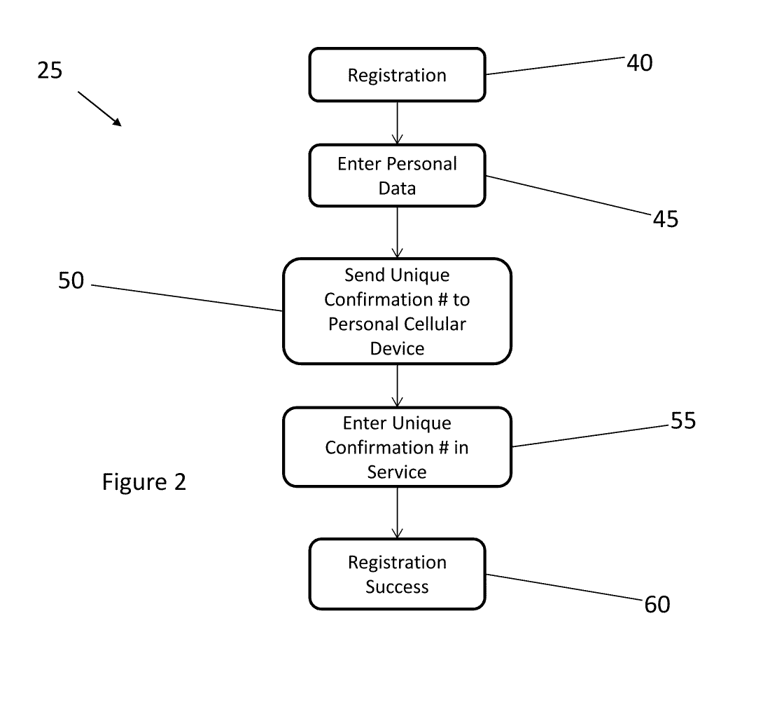

With reference to FIG. 2 and according to one embodiment of the present invention, the logic diagram of the registration process of step 25 is shown in detail, generally comprising of step 40 which consists of the acceptance of the registration process. In order to first register, the user must enter personal data in step 45. Personal data must include a multitude of identifiers in order to distinguish between similar persons when the user is searched in the database. As such, the system 10 will request for information regarding first name, last name, e-mail address, password, employer, education level (which school and what years those schools were attended), any clubs or affiliations, city of birth and current city of residence, etc. Indeed, a worker skilled in the relevant art would appreciate that a plethora of identifiers can be asked during step 45 in order to further distinguish each user. It should further be noted that a unique identifier must be included in the registration process data, which consists of a telephone number, usually a cellular telephone number. The unique identifier of the cellular telephone number will not be displayed unless specifically instructed so, whereas other information such as the password will obviously not be displayed. Therefore, with this information, the system 10 will create an account for each registered user and provide a directory of registered users with each registered user having at least one identifier and one unique identifier. Once the requisite information has been entered and accepted by the system 10, said system 10 will proceed to step 50 which consists of sending a unique confirmation code to the cellular telephone number specified in step 45. Once the confirmation code has been received by the user, said user must enter the code into the system 10 in step 55 to confirm that the cellular telephone is in fact his or hers. This level of security allows the system 10 to confirm that the user does in fact have access to the cellular telephone number as described in step 45. Once the correct confirmation code has been entered into the system 10, the registration is successful in step 60 and the user has been registered into the system 10. If, on the other hand, the confirmation code entered is incorrect, the user will have a small, finite amount of attempts to enter the correct number before having to send another confirmation code.

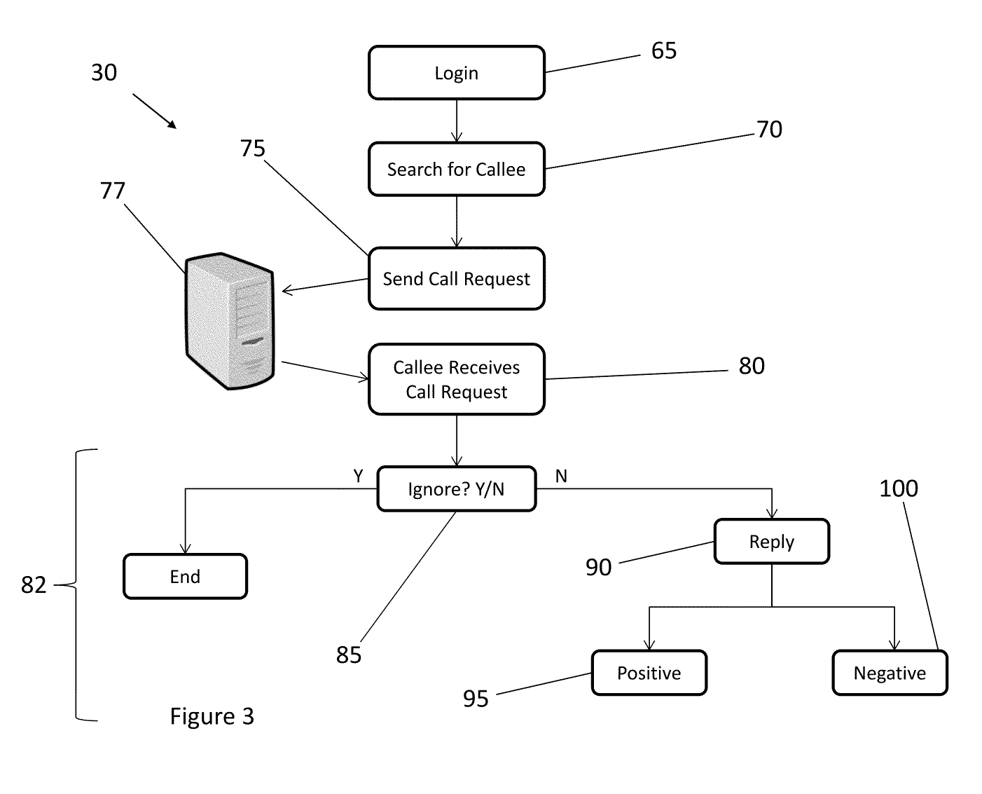

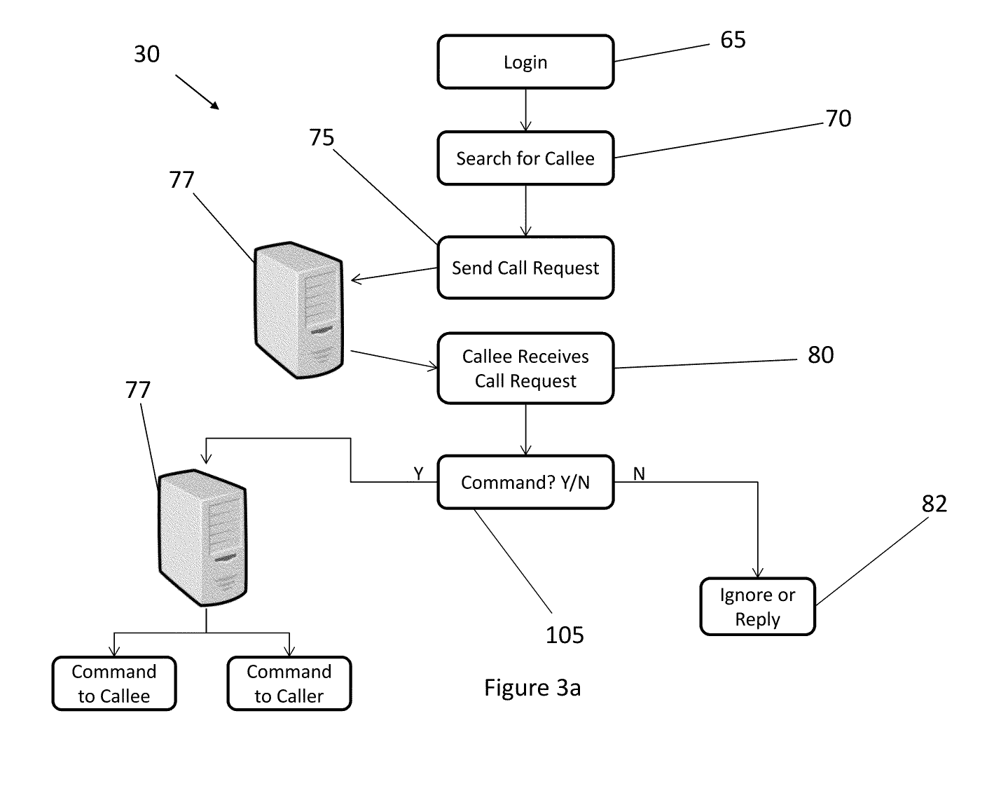

With reference to FIG. 3 and according to one embodiment of the present invention, the logic diagram of the cellular telephony directory search and contact step 30 is shown in greater detail. Said step 30 primarily consists of logging into the system 10 via step 65. In other words, the user must enter his or her username and password in order to access the database of registered users. Once logged into the system 10 the first registered user (caller) can search for a second registered user (callee) in step 70. The caller can use several search criteria in order to submit an identifier search query to find the callee. Indeed, almost all of the information which was input in step 45 (not shown) other than in most cases the unique identifier (the personal cellular telephone number) can be looked up in order to find and identify the proper callee. Once the system 10 has accepted the identifier search query and matched the identifier information submitted by the caller in the identifier search query with that of the callee, the caller can send a communication request such as a call request to said callee at step 75. The communication request will be comprised of the unique identifier of the caller in order for the callee to have the opportunity to contact the caller. Under normal operating circumstances, the caller will only be able to send a call request to different users per step 75 three (3) times over a period of twenty four (24) hours, or to the same user per step 75 once over a period of twenty four (24) hours. This limitation will remove the ability for a caller to make multiple requests which could spam the system 10. A worker skilled in the relevant art would appreciate that the number or call requests per step 75 could be augmented to more or less than three, or that the period to send the requests can be more or less than one day. In one embodiment, the possible spam of a caller attempting to send requests to every registered user is eliminated. Once the caller initiates the request, said request is sent to a server 77 which then forwards the request to the callee. The request is received at step 80, and said call request consists of any type of Mobile Notification Service (MNS) such as Short-Message (SMS), Enhanced Short-Message (EMS), Multi-Media Message (MMS), plain e-mail, paging service, or other message format, sent directly to the person's cellular telephone number, which can be easily accessed from the callee's default messaging application. As such, no software is required to receive the message: the callee is only required to be a registered user on the system 10. When the server 77 sends the MNS to the callee, said MNS will be forwarded to a gateway which will in turn forward the request to the callee. Said MNS will use different numbers for outbound messages, such that when the MNS is received it will appear to originate from a random telephone number. Once the call request MNS is received by the callee at step 80, there are two options available per step 82, as the callee must determine if said callee wishes to ignore the request per step 85 or not. Ignoring the request at step 85 is simple and the callee does not have to take any action, and the caller will only be able to send another request per step 75 at least twenty four hours later. The callee can also reply to the caller at step 90, by means of sending a positive MNS back or even just initiating a call per step 95, or sending a negative MNS back per step 100. By initiating a call or sending an MNS stating that the callee would like to accept the call, the call is about to take place. The callee can also send an MNS to state that said callee would rather not be contacted per step 100. The pitfall of this negative reply at step 100 is that the caller can have access to the phone number of the callee by virtue of receiving the call or MNS indicating otherwise. A worker skilled in the relevant art would appreciate that the request sent and received at steps 75, 80 do not have to be limited to a standard call. Indeed, said step 75, 80 could also extend to making other types of requests such as a request for a video transmission, a general request for a type of connection, a request for a permission to effect some type of communication, a request to schedule or coordinate a meeting, etc. Indeed, a worker skilled in the relevant art would appreciate that a variety of requests can be sent without departing from the spirit and scope of the invention.

With reference to FIG. 3a and according to a second embodiment of the present invention, an alternative logic diagram of the cellular telephony directory search and contact step 30 is shown in greater detail. In this alternative embodiment, in addition to having all of the options that were outlined in step 82, the caller has the additional option of issuing a command at step 105 which is sent back and received by the server 77. A worker skilled in the relevant art would appreciate that the command at step 105 could encapsulate a variety of commands without departing from the scope of the device. For simplicity, only three commands will be discussed. Firstly, the callee could command to “ignore”, such that the server 77 would stop allowing the caller to send requests per step 75, without alerting the caller that his or her future requests are being ignored. In another embodiment, the callee could “deny” the call request, such that the server would send a message back to the caller and alert said caller that his or her request was denied by the callee. In another embodiment, the callee could command the server 77 for “more information” such that the server 77 would send another message or query for additional information from the caller. In yet another embodiment, the callee could command the server 77 “later” which could prompt the server 77 to remind the callee of the request at a later time; this would be ideal for callee that are in meetings or otherwise occupied and may forget about the request until said later time. Indeed, a worker skilled in the relevant can appreciate that many types of commands would be possible in this type of system architecture to facilitate the potential call.

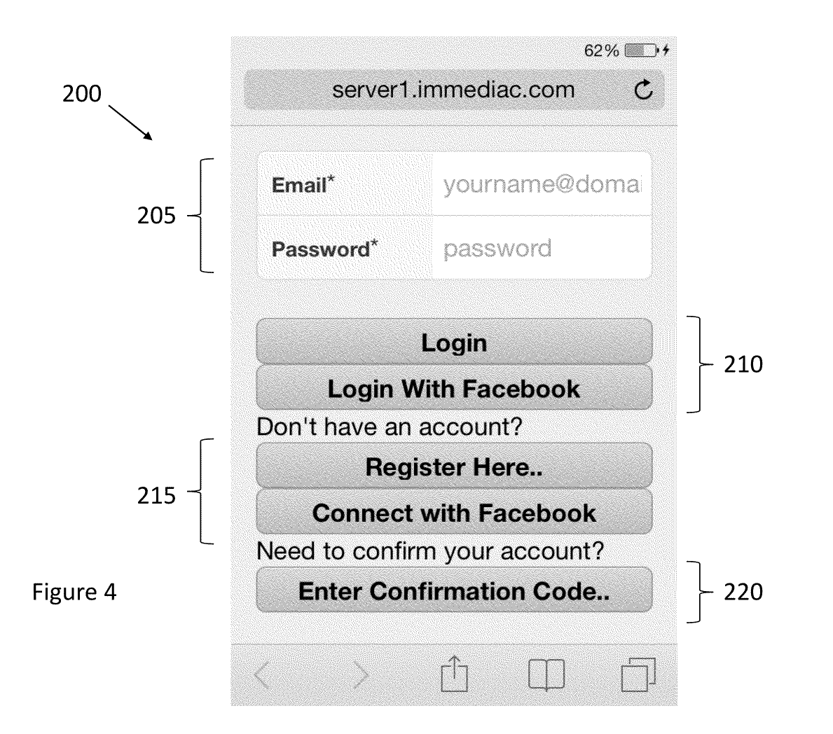

With reference to FIG. 4 and according to one embodiment of the present invention, a screenshot of the login page 200 is shown. According to the login page 200, if the user has already been registered with the system 10, he or she can log in directly by inputting a username and password at step 205. One these values have been inputted, the user can either login traditionally, or simply choose to login with his or her Facebook account as per step 210. If the user is not registered, said user has the option to register traditionally or register with Facebook at step 215. If the user is new and has already gone through the registration process and obtained a confirmation code, said user can input that value by selecting the enter confirmation code button at step 220.

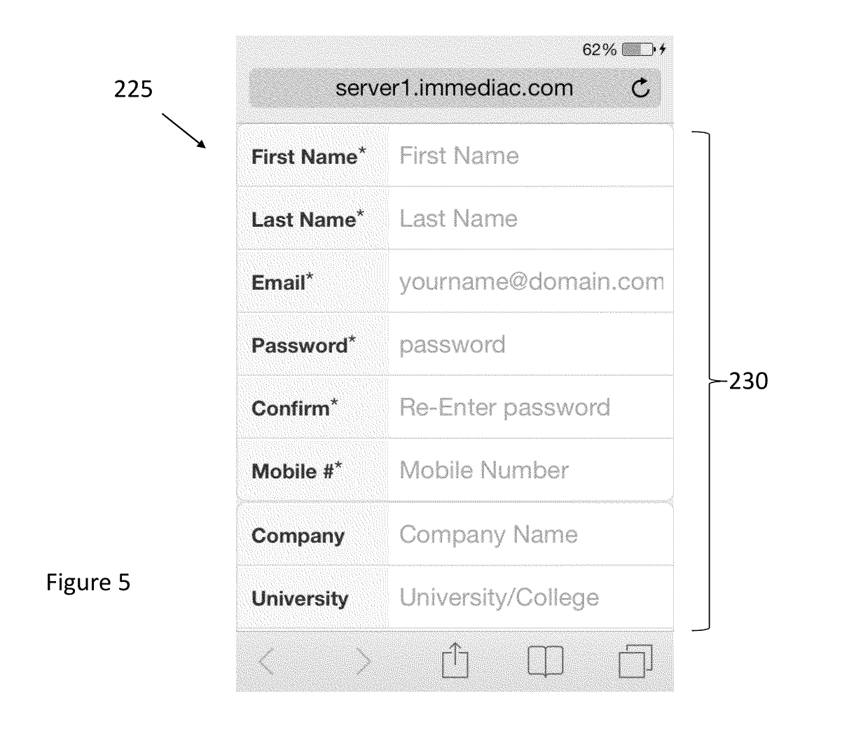

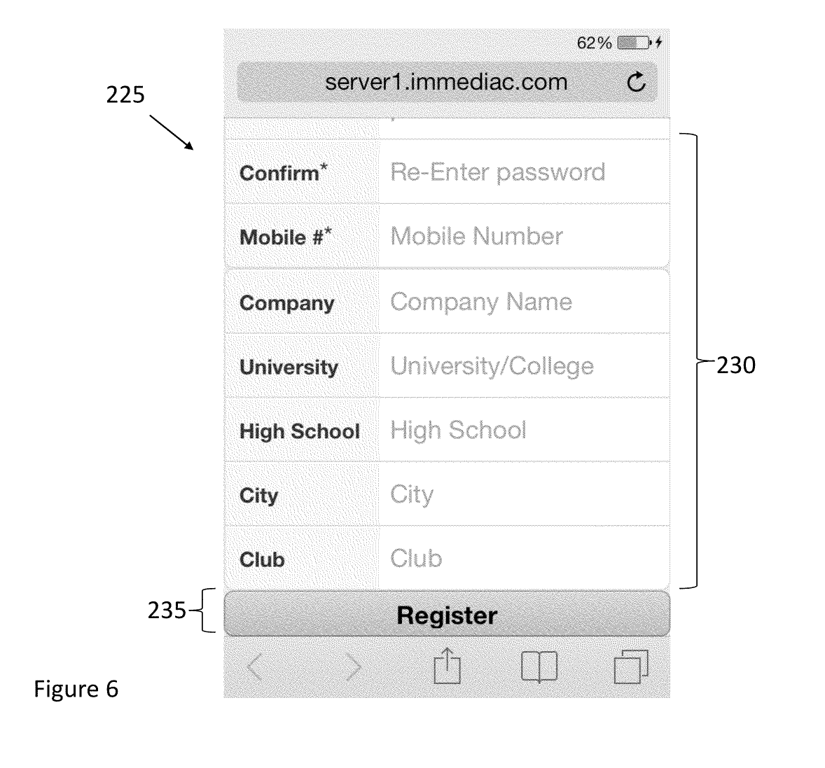

With reference to FIGS. 5 and 6 and according to one embodiment of the present invention, two screenshots of the registration page 225 are shown. During the registration process, the unregistered user must input information as required to create an account. This information will include, as was mentioned above, a name, e-mail, a password for the account, a mobile number to be reached at, and then the unregistered user must also include other personal identifiable (PID) information at step 230. Once this information has all been entered, the unregistered user must register at step 235. Once the information has been entered, the server sends a confirmation code to the mobile number which was entered in step 230, usually by way of SMS.

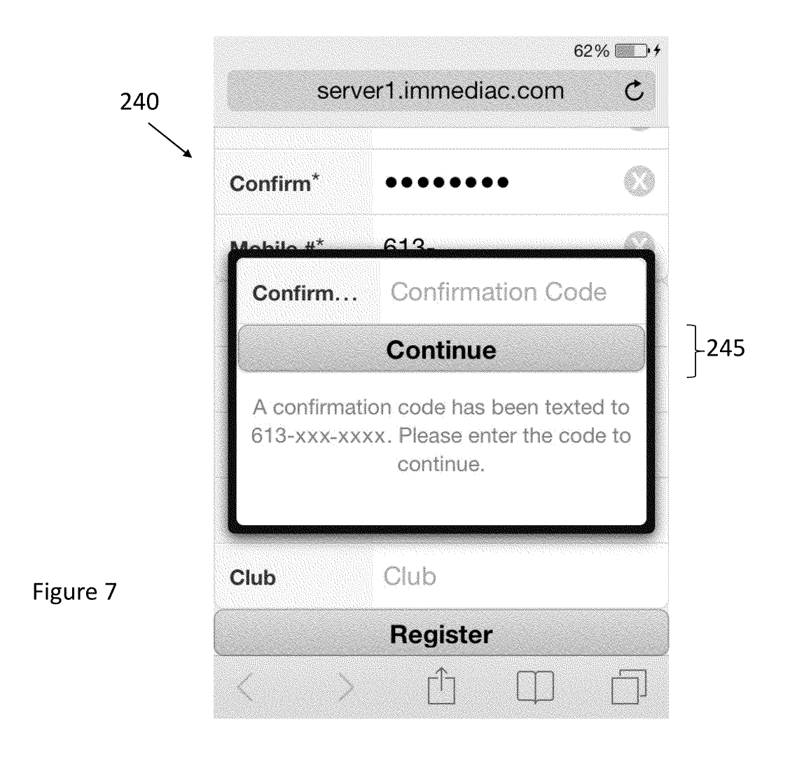

With reference to FIG. 7 and according to one embodiment of the present invention, a screenshot of the confirmation screen 240 is shown. This confirmation screen 240 is shown once the information obtained in step 230 (not shown) has been entered and the unregistered user elects to register at step 235 (not shown). The unregistered user must then enter his or her registration code, which was sent via SMS to the mobile number entered. Once done so, the unregistered user selects the continue button at step 245.

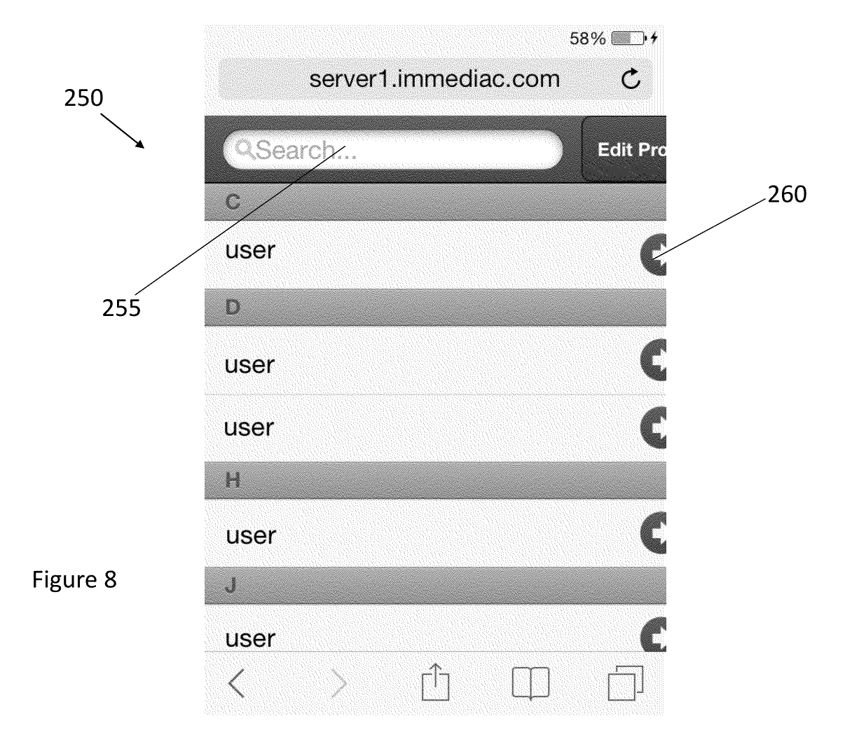

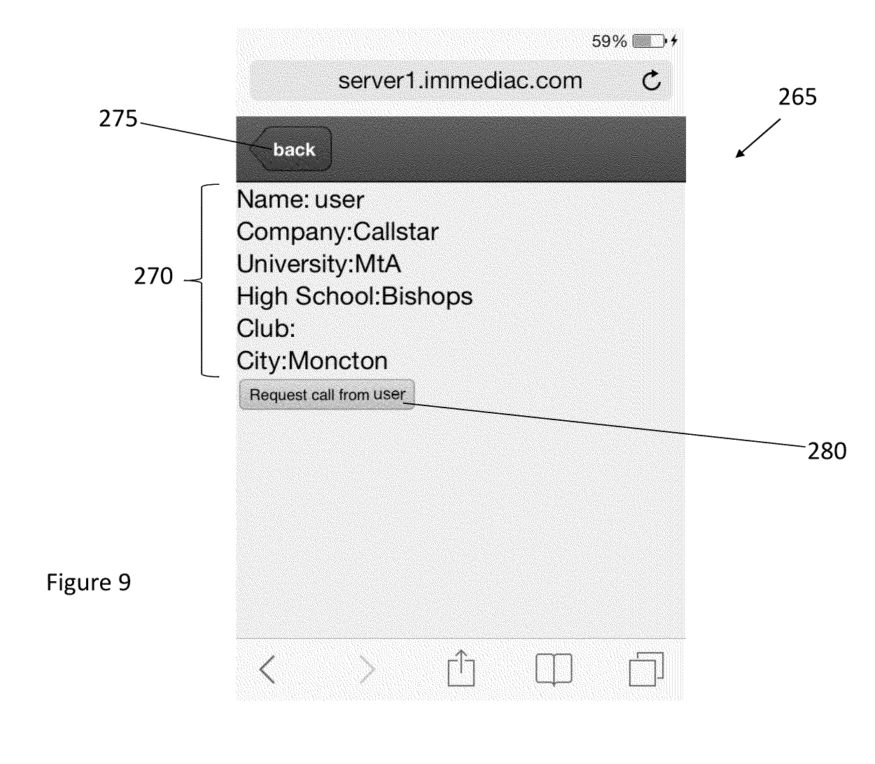

With reference to FIG. 8 and according to one embodiment of the present invention, a screenshot of the list of users 250 is shown. Under normal operating circumstances, the list of users 250 would be more densely populated such that all the registered users would be accessible and viewable in this list 250. In order to conduct a search, the registered user simply needs to enter a parameter in the search field 255 such as a name, school, location, or other PID information. The system 10 will identify the relevant registered user that is being searched and display all contacts who match those parameters. Once the field of users (potential callees) has been narrowed, the user searching (the caller) can select each potential callee by selecting the arrow 260 which will take the caller to another information screen (as shown in FIG. 9).

With reference to FIG. 9 and according to one embodiment of the present invention, a screenshot of a registered user information 265 is shown. In said registered user information screen 265, PID information 270 is displayed in order for the caller to determine if the potential callee is in fact the correct one. If the caller determines that this is not the appropriate callee, the caller will select the back button at step 275 and return to the list of users screenshot 250 (not shown). Conversely, if the caller has determined that this callee is the appropriate person, the caller simply selects the request call button at step 280. Selecting this request call button at step 280 will prompt the system 10 to send an MNS to the callee in order to determine if this callee would like to initiate a phone conversation.

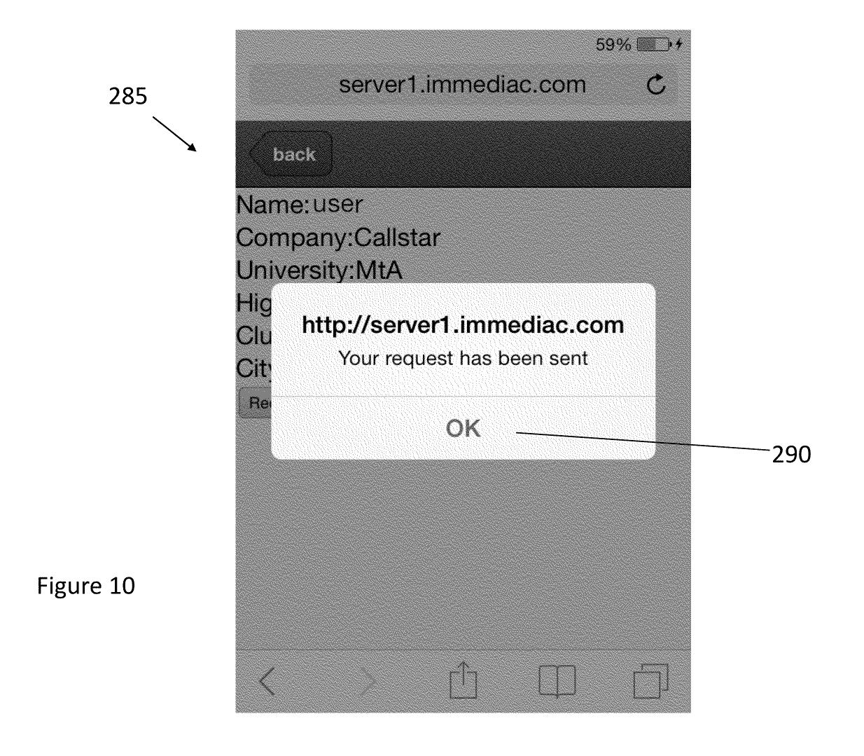

With reference to FIG. 10 and according to one embodiment of the present invention, a screenshot of the confirmation message 285 which confirms that the request has been sent is shown. Said confirmation message screenshot 285 appears once the caller has selected the request call button 280 (shown in FIG. 9). By pressing the OK button at step 290, the caller returns to the previous menu which displayed the callee PID information at the registered user information screenshot 265 (not shown).

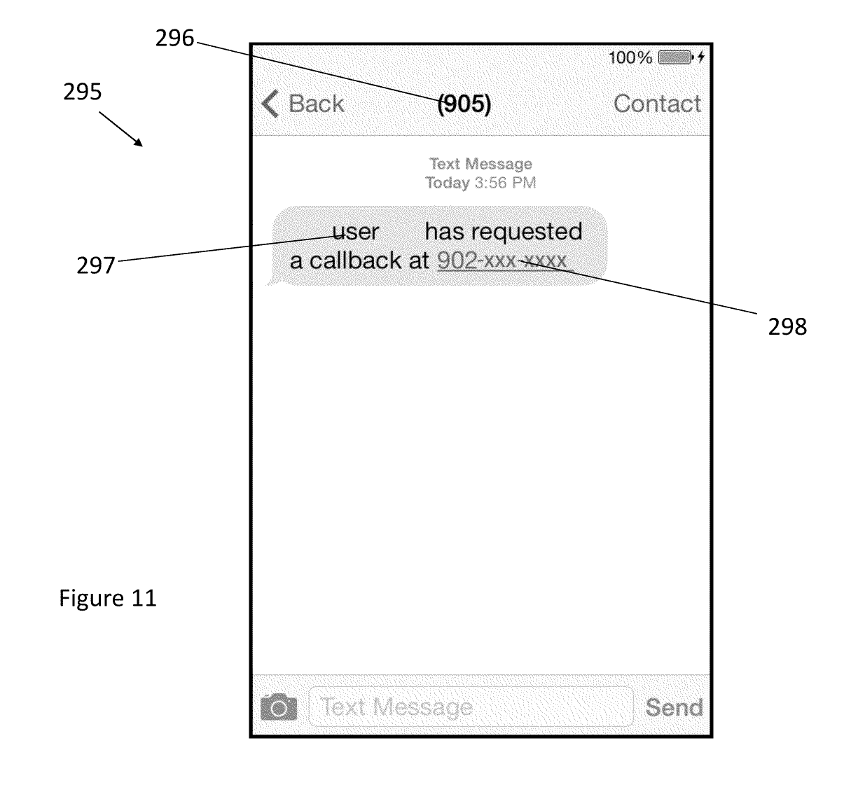

With reference to FIG. 11 and according to one embodiment of the present invention, a screenshot of the SMS from the server (not shown) sent via the SMS Gateway 295 which was initiated by the caller attempting to make contact with the callee is shown. This particular embodiment shows the less intelligent system, whereby the server (not shown) cannot receive any type of command in return. Indeed, the server (not shown) simply sends a message from a random telephone number 296, which displays the caller's name 297 and the caller's mobile number 298. The only options the callee has available are to ignore or reply directly to said caller.

Although the invention has been described above by reference to certain embodiments of the invention, the invention is not limited to the embodiments described above. Modifications and variations of the embodiments described above will occur to those skilled in the art in light of the above teachings. Moreover, with respect to the above description, it is to be repulsed that the optimum dimensional relationships for the component members of the present invention may include variations in size, material, shape, form, funding and manner of operation. It is further understood that this system can be used in standalone format or in conjunction with another application such as Facebook™, Twitter™, LinkedIn™, Skype™, etc without departing from the spirit of the invention.

The present invention provides a method for sending a communication request to a second registered user via a cellular network, the method comprising:
a) providing a directory of registered users with each registered user having at least one identifier and one unique identifier;
b) accepting an identifier search query from a first registered user;
c) matching the identifier from the identifier search query with the second registered user from the directory; and
d) sending the communication request from the first registered user to the unique identifier of the second registered user;
   wherein the communication request is comprised of the confidential identifier of the first registered user.

The present invention also provides a system for providing method for sending a communication request to a second registered user via a cellular network, the system comprising:
e) An application for providing a directory of registered users with each registered user having at least one identifier and one unique identifier;
f) An application for accepting an identifier search query from a first registered user;
g) An application for matching the identifier from the identifier search query with the second registered user from the directory; and
h) An application for sending the communication request from the first registered user to the unique identifier of the second registered user;
   wherein the communication request is comprised of the confidential identifier of the first registered user. A worker skilled in the relevant art would be familiar with application that allow to provide a system encompassing this method.

Having thus described the invention, it is now claimed:

1. A method for sending a communication request to a second registered user via a cellular network, the method comprising:
a) providing a directory of registered users with each registered user having at least one identifier and one unique identifier;
b) accepting an identifier search query from a first registered user;
c) matching the identifier from the identifier search query with the second registered user from the directory; and
d) sending the communication request from the first registered user to the unique identifier of the second registered user;
wherein the communication request is comprised of the confidential identifier of the first registered user.

2. The method of claim 1 further comprising creating an account based on the unique identifier and the at least one identifier of the registered user prior to providing the directory of registered users.

3. The method of claim 1 further comprising receiving the at least one identifier and the one unique identifier from an unregistered user and sending a confirmation code to the unregistered user to create the directory of registered users.

4. The method of claim 1 further comprising receiving a command from the second registered user after sending the communication request from the first registered user.

5. The method of claim 4 wherein an ignore command is received and the first registered user is prevented from sending further communication requests.

6. The method of claim 4 wherein a deny command is received and a message is sent to the first registered user to alert the first registered user that the communication request was denied.

7. The method of claim 4 wherein a more information command is received and a message is sent to the first registered user to query for additional information from the first registered user.

8. The method of claim 1 wherein the communication request is in the form of a Mobile Notification Service (MNS) such as Short-Message (SMS), Enhanced Short-Message (EMS), Multi-Media Message (MMS), plain e-mail, paging service, voice memorandum, and other communication format.

9. The method of claim 1 wherein the unique identifier is a telephone number.

10. The method of claim 1 wherein the communication request can only be sent up to three times in a twenty-four hour span to prevent spamming.

11. A system for providing method for sending a communication request to a second registered user via a cellular network, the system comprising:
a) an application for providing a directory of registered users with each registered user having at least one identifier and one unique identifier;
b) an application for accepting an identifier search query from a first registered user;
c) an application for matching the identifier from the identifier search query with the second registered user from the directory; and
d) an application for sending the communication request from the first registered user to the unique identifier of the second registered user;
wherein the communication request is comprised of the confidential identifier of the first registered user.
